(19) United States
(12) Patent Application Publication
(10) Pub. No.: US 2003/0151598 A1
(43) Pub. Date: Aug. 14, 2003

(54) Uses for truck cam

(76) Inventor: Thomas Andrew Sutor, Lompoc, CA (US)

Correspondence Address: THOMAS A. SUTOR, P O BOX 2343, LOMPOC, CA, 93438, US

(21) Appl. No.: 09/816,530

(22) Filed: Feb. 13, 2002

(51) Int. Cl. G09G 5/00

(52) U.S. Cl. 345/204

(57) ABSTRACT

My invention, the “TRUCK-CAM”, is simply an LCD screen positioned in full view of the driver with mini-cams strategically placed at the back, sides and front of the truck. This will allow the driver an un-before view, previously blind to him. I feel confident that with my device in use, truck safety will be heightened tremendously. The technology is here, all that is needed is for the “TRUCK-CAM” to become a reality.

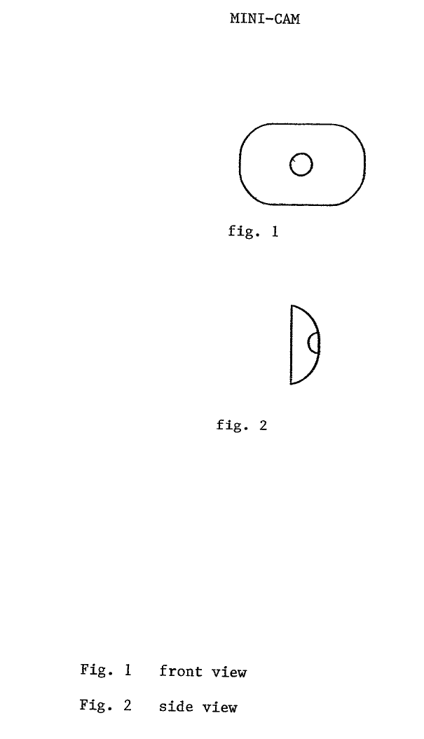

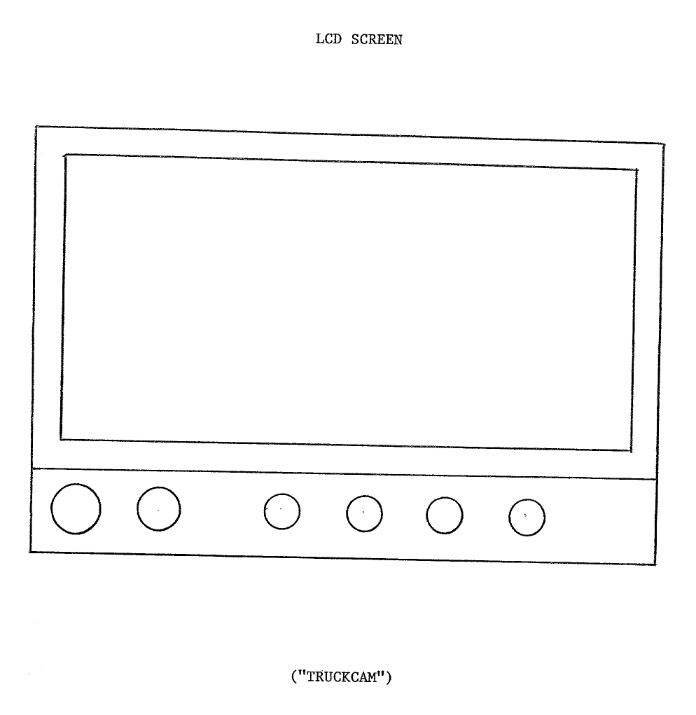

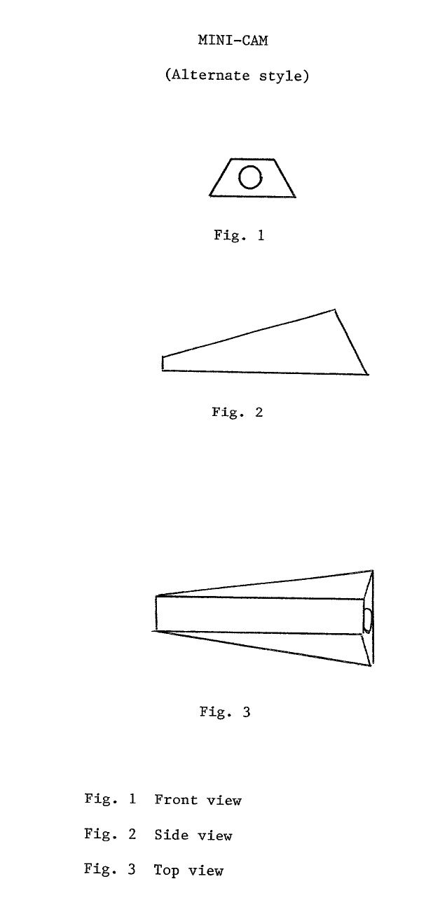

### DESCRIPTION OF INVENTION

The truck cam will consist of two main parts; first it will require a LCD screen that will have a power button to turn it on. The LCD screen will also have a view button for different views. It will also have four buttons for main view of a truck cam placed on the truck.

The LCD screen is the first part of this conceptual idea. The design is open to interpretation for those who would like to design a look. I have enclosed with this documentation a drawing of what the LCD screen will look like.

The LCD screen will be like a mini microcomputer. Its functions will be to process images from truck cam's placed on a semi truck. The LCD screen would receive its information from the truck cams with cables or radio transmitter.

The truck cam is basically a Web cam designed to fit on a truck. The truck cam would be placed on the back of the truck. This would be the main use for the truck cam so that a driver could see behind him. Semi-trucks have basically four blind spots. The rear, the right side, the left side, and in the very front. The truck cams could be placed at all of the blind spots the semi truck driver is unable to see.

The truck cam delivers better visibility than the mirrors that only give a limited view to a semi truck driver. With the LCD screen mounted in the driver's area for easy reference, the driver can see cars behind him, cars to the right or left of him and directly below him in the front.

The power source for this device would run off the truck engine. It's as simple to set up the LCD screen with the four cams as it would be to set the standard stereo in an automobile. The truck cam would relay video images in real time. The images would be seen exactly as they were. Not closer than they actually they were. The images could be seen in black and white, or color. The CAM devices would be able to give night vision as well.

The LCD screen would be detachable so that the driver could take the LCD screen into his hotel and monitor his truck from his room. This would add extra safety to the shipment and the driver's ability to protect his truck. The LCD screen would have the ability to incorporate GPS technology, cell phone technology, and digital recording technology.

Materials Needed for the Truck CAM

LCD screen

Video Cams

Power cables

Plastic clear casing

Attachment hardware

Screws nuts and bolts

Attachment clips

Metal video casing

Electrical wiring

Computer processor

Anodized metal

Power button

Function buttons

Proximity warning

Radio antenna

Radio transmitter

Radio receiver

Adhesives

Warning device

Zoom lens “for trains”

Night vision

GPS device

Cell phone hookup

Typing keyboard

E-mail receiver

Digital recorder

Power antenna

Video processor

Function processor

Software

These are the main items that will be needed to create and install the truck cam on any truck of commercial size.

Other Uses for the Truck CAM

I envision the use of the truck CAM for multiple organizations. I am listing here some of the most important trucking industry and large land-based vehicles in the world.

Semi trucks

Armored trucks

Presidential vehicles

Motor homes

Space Support Vehicles

The buses, inner city, airport, travel, and vacation.

Rental vehicles such as U-Haul

Commercial truckers

Fire trucks

Emergency vehicles

Military vehicles

UPS and FedEx type trucks

Post Office trucks

Large industrial vehicles

Front of trains

Beverage trucks

Produce trucks

Retail trucks

Animal trucks

Distributors of snack items trucks

This is the main list of the types of vehicles that will use the truck cam.

Benefits of the Truck Cam

I believe that with the development and production of this device, many lives will be saved. I think it most important that the conceptualization of the truck Cam becomes a reality. Below I list what I believe are some of the more outstanding safety features of this invention

Save lives

Prevent accidents

Increased range of visibility

Night vision

Preventing docking accidents

Semi truck drivers will have the ability to turn around in the most unlikely places without the need for a second person.

Lower insurance policies for truckers who use the device.

Works in all weather conditions.

Able to turn into lanes and see if it's clear. This will prevent truck drivers from running cars off the highway.

Helps inexperienced drivers feel more confident.

Estimated Costs of Installing A Device per Truck

Truck cam with one cam estimated $150.00 per truck

Truck cam with two cams estimated $180.00 per truck

Truck cam with four cams estimated $225.00 per truck

Estimated cost for truck cam would range from anywhere between $150.00 to $400.00 depending on how many extra features requested to be installed with the basic system.

Once again I would like to reiterate that I have a logbook that has all the conceptual data from the original conception of this invention on Oct. 27, 2000. I believe professionals with the technological skill can understand how to create and develop this conceptual invention from what I have submitted herein.

My name is Thomas A. Sutor. I am the sole inventor of the truck cam. I believe I have listed here with my best ability what the truck cam is. I believe I have described its function, creation, and implementation.

What I claim as my invention is:

1. A safety device for trucks which I call, the ‘truck-cam’:
Helps to eliminate, ‘blind-spots’ when operating a vehicle.
Allows driver of semi-trucks and large vehicles to see all areas of importance.
Can be installed easily.
Affordably priced.
By reducing accidents, would in turn lower insurance premiums.
With the increased volume of truck traffic on the highways today, it is my contention that the ‘TruckCam’ will be a boon to the trucking industry.
